(19) United States
(12) Patent Application Publication
(10) Pub. No.: US 2026/0343071 A1
(43) Pub. Date: Oct. 29, 2026

(54) Subscriber-Generated Media Transmission Method And Apparatus

(71) Applicant: Electronics and Telecommunications Research Institute, Daejeon (KR)

(72) Inventors: Dong Joon CHOI, Daejeon (KR); Jae Hyun SEO, Daejeon (KR)

(73) Assignee: Electronics and Telecommunications Research Institute, Daejeon (KR)

(21) Appl. No.: 19/655,929

(22) Filed: Apr. 23, 2026

(30) Foreign Application Priority Data
Apr. 25, 2025 (KR) 10-2025-0054472

(51) Int. Cl. H04N 21/8547; H04N 21/242; H04N 21/437; H04N 21/44; H04N 21/643; H04N 21/658

(52) U.S. Cl. CPC H04N 21/8547; H04N 21/242; H04N 21/437; H04N 21/44008; H04N 21/64322; H04N 21/658

(57) ABSTRACT

Disclosed are a subscriber-generated media transmission method and apparatus. According to one aspect of the present disclosure, there is provided a subscriber-generated media transmission method comprising: classifying media data generated by a subscriber terminal into one of audio information, video information, and text by applying the media data as input to a deep learning model; synchronizing an internal clock (local synchronized clock) of the subscriber terminal based on reference timing information generated by a control server; extracting predetermined types of features from the classified media data using the deep learning model based on a feature extraction guide message generated by the control server and including configuration values for extracting feature vector data and parameters to be applied to the deep learning model; inserting timestamps, which are time information indicating times at which the features are extracted, into feature vector data and transmitting the feature vector data to a node server to which the subscriber terminal is connected; and receiving upstream media data generated by the control server, wherein the upstream media data is generated using a generative AI model based on merged feature vector data obtained by merging feature vector data received from a plurality of subscriber terminals belonging to the same subscriber group as the subscriber terminal, based on a feature merge guide message generated by the control server and including configuration values for merging feature vector data and parameters to be applied to the deep learning model.

### CROSS-REFERENCE TO RELATED APPLICATION

The present application claims priority to Korean Patent Application No. 10-2025-0054472, filed on Apr. 25, 2025 in the Korea Intellectual Property Office, the entire contents of which are incorporated herein by reference.

### TECHNICAL FIELD

The present disclosure relates to a subscriber-generated media transmission method and apparatus.

### BACKGROUND

The statements in this section merely provide background information related to the present disclosure and do not necessarily constitute prior art.

With the popularization of the Internet, various non-face-to-face services have emerged, and online-based services such as cultural performances, remote conferences, and remote lectures have been actively attempted; however, in their early stages, such services failed to receive significant user engagement. Recently, triggered by the COVID-19 pandemic, conventional face-to-face performances, meetings, and educational activities have been converted to online formats, and accordingly, demand for and interest in non-face-to-face services have increased explosively. In particular, with the advancement of communication network technologies such as 5G and ultra-high-speed Internet, as well as the widespread distribution of personal mobile terminals and various smart devices, the feasibility of diverse online services has become a reality, and the introduction of related industries has been expanded in earnest.

In line with this trend, online services have become established not merely as temporary countermeasures during a pandemic period, but as new business models capable of overcoming limitations of conventional offline services, such as spatial constraints, cost issues, and limitations on the number of participants. In particular, services in which a large number of users simultaneously access, such as online lectures, performances, and streaming video services, have been increasing, and such services are confronted with situations requiring accommodation of simultaneous users ranging from dozens to millions.

To provide high-quality media services to a large number of subscribers, ultra-high-quality video and audio media acquisition technologies, high-performance compression technologies, and high-efficiency transmission schemes have been introduced, through which more stable service provision has become possible. In addition, in order to maintain media transmission quality, a strategy of distributing network load by constructing distributed Content Delivery Networks (CDNs) within transmission networks has been employed. Recently, Mobile Edge Computing (MEC) technology, in which high-performance computing resources are deployed in network segments closest to user terminals, has also been introduced to improve downstream service quality. Accordingly, transmission of media content from service providers to subscriber terminals has been performed in a relatively stable manner.

However, most conventional systems are optimized for downstream services, and limitations exist in upstream services, that is, media transmission for subscriber participation. For example, despite increasing demand for participatory services such as learners'questions and responses in online education and audience reactions in remote performances, there are limitations in upstream bandwidth for accommodating participatory media traffic generated by subscribers. In particular, in systems such as video conferencing systems, due to structures in which only media of certain participants can be transmitted in a limited manner, it is difficult to transmit upstream media of a large number of participants in real time.

Recently, with the emergence of large-scale participatory platforms such as the metaverse, limitations of conventional upstream processing have become more pronounced. In metaverse services, millions of users may simultaneously access a single session, or a large number of sessions may be generated within a single metaverse platform, with a large number of users participating in each session. In such environments, conventional high-performance compression technologies and high-efficiency media transmission schemes alone have limitations in effectively processing massive amounts of media traffic generated by subscribers.

### SUMMARY

An object of the present disclosure is to provide a media transmission system and method capable of resolving problems of conventional systems, such as network load, limitations in upstream bandwidth, and difficulty in supporting real-time participation, which occur in upstream media traffic processing in conventional large-scale user participatory services, and of efficiently supporting participation of a large number of users.

An object of the present disclosure is to provide an architecture capable of improving inefficiencies in upstream processing inherent in conventional downstream-centered network architectures, and of stably transmitting a large volume of upstream media traffic generated by subscriber terminals while minimizing network load.

An object of the present disclosure is to overcome capacity limitations of large-scale upstream transmission that could not be resolved by conventional high-performance compression technologies and high-efficiency transmission schemes alone, and to provide a system that enables millions of users to participate in real time even in various non-face-to-face service environments such as metaverse services, remote performances, and large-scale online lectures.

An object of the present disclosure is to provide a technique capable of ensuring stable service quality without requiring additional expansion of existing network infrastructure, by optimizing data processing and transmission processes between a node server and a control server.

The technical objects of the present disclosure are not limited to those described above, and other technical objects not mentioned above may be understood clearly by those skilled in the art from the descriptions given below.

An embodiment of the present disclosure provides subscriber-generated media transmission method comprising: classifying media data generated by a subscriber terminal into one of audio information, video information, and text by applying the media data as input to a deep learning model; synchronizing an internal clock (local synchronized clock) of the subscriber terminal based on reference timing information generated by a control server; extracting predetermined types of features from the classified media data using the deep learning model based on a feature extraction guide message generated by the control server and including configuration values for extracting feature vector data and parameters to be applied to the deep learning model; inserting timestamps, which are time information indicating times at which the features are extracted, into feature vector data and transmitting the feature vector data to a node server to which the subscriber terminal is connected; and receiving upstream media data generated by the control server, wherein the upstream media data is generated using a generative AI model based on merged feature vector data obtained by merging feature vector data received from a plurality of subscriber terminals belonging to the same subscriber group as the subscriber terminal, based on a feature merge guide message generated by the control server and including configuration values for merging feature vector data and parameters to be applied to the deep learning model.

Another embodiment of the present disclosure provides subscriber-generated media transmission method comprising: synchronizing an internal clock of a node server based on reference timing information generated by a control server; sorting and merging, in chronological order based on timestamps included in feature vector data and indicating times at which the feature vector data are extracted, feature vector data received from a plurality of subscriber terminals included in a subscriber group connected to the node server, based on a feature merge guide message generated by the control server and including configuration values for merging feature vector data and parameters to be applied to a deep learning model; transmitting merged feature vector data to the control server; transmitting upstream media data generated by the control server to the plurality of subscriber terminals; and transmitting, to the subscriber terminals, a feature extraction guide message generated by the control server and including configuration values for extracting feature vector data and parameters to be applied to the deep learning model, and the reference timing information, wherein the upstream media data is generated using a generative AI model based on merged feature vector data obtained by merging feature vector data received from a plurality of subscriber terminals belonging to the same subscriber group as the subscriber terminal, based on a feature merge guide message generated by the control server and including configuration values for merging feature vector data and parameters to be applied to the deep learning model.

Another embodiment of the present disclosure provides subscriber-generated media transmission method comprising: sorting, in chronological order based on reference timing information, feature vector data received from a plurality of subscriber terminals belonging to the same subscriber group as a subscriber terminal, and merging the sorted feature vector data based on a feature merge guide message generated by a control server and including configuration values for merging feature vector data and parameters to be applied to a deep learning model; generating upstream media data using a generative AI model based on the merged feature vector data; transmitting the upstream media data to node servers; and generating and transmitting the reference timing information, a feature extraction guide message, and the feature merge guide message to the node servers.

According to another aspect of the present disclosure, there is provided an apparatus comprising: at least one memory storing instructions; and at least one processor, wherein the at least one processor executes the instructions to perform: synchronizing an internal clock of a node server based on reference timing information generated by a control server; sorting and merging, in chronological order based on timestamps included in feature vector data and indicating times at which the feature vector data are extracted, feature vector data received from a plurality of subscriber terminals included in a subscriber group connected to the node server, based on a feature merge guide message generated by the control server and including configuration values for merging feature vector data and parameters to be applied to a deep learning model; transmitting merged feature vector data to the control server; transmitting upstream media data generated by the control server to the plurality of subscriber terminals; and transmitting, to the subscriber terminals, a feature extraction guide message generated by the control server and including configuration values for extracting feature vector data and parameters to be applied to the deep learning model, and the reference timing information, wherein the upstream media data is generated using a generative AI model based on merged feature vector data obtained by merging feature vector data received from a plurality of subscriber terminals belonging to the same subscriber group as the subscriber terminal, based on a feature merge guide message generated by the control server and including configuration values for merging feature vector data and parameters to be applied to the deep learning model.

According to embodiments of the present disclosure, limitations in upstream processing inherent in conventional downstream-centered network architectures are overcome, and real-time participation of a large number of users can be effectively supported.

According to embodiments of the present disclosure, upstream media traffic generated at subscriber terminals is reduced based on feature vectors, and network load is minimized through multiplexing and encapsulation over IP, thereby making it possible to address capacity limitations of the upstream.

According to embodiments of the present disclosure, through distributed processing via node servers and an optimized data merging process of a control server, upstream media can be transmitted in real time even in large-scale session environments in which millions of users simultaneously participate.

According to embodiments of the present disclosure, quality of audio/speech, video, and text data is improved by utilizing a generative AI model, and the data can be reconstructed into content in a form desired by a service provider.

According to embodiments of the present disclosure, transmission efficiency between a node server and a control server is maximized, thereby maintaining service quality without additional expansion of existing network infrastructure and reducing operational resources and costs.

According to embodiments of the present disclosure, compared to conventional upstream processing, the amount of data transmission is reduced and transmission latency is minimized, thereby making it possible to provide a system suitable for service environments in which real-time performance is critical, such as online performances, remote conferences, and metaverse services.

According to embodiments of the present disclosure, by generating guide messages including parameters to be applied to a generative AI model and controlling media restoration and reconstruction based thereon, a service provider can flexibly provide customized media content to various subscriber groups.

According to embodiments of the present disclosure, by merging and restoring feature vector data based on time synchronization and re-extracting features, it is possible to provide an upstream media service with improved visual consistency and coherence.

According to embodiments of the present disclosure, by extracting and merging features at subscriber terminals and node servers, subscriber-generated media can be light weighted, and high-quality immersive services can be provided based on the merged features.

According to embodiments of the present disclosure, by precisely synchronizing internal clocks among subscriber terminals, node servers, and a control server based on reference timing information, latency among media data generated by a plurality of subscriber terminals can be minimized, and service immersion can be enhanced.

The technical effects of the present disclosure are not limited to the technical effects described above, and other technical effects not mentioned herein may be understood to those skilled in the art to which the present disclosure belongs from the description below.

### BRIEF DESCRIPTION OF THE DRAWINGS

FIG. 1 is an exemplary diagram illustrating a conventional one-way media providing method.

FIG. 2 is an exemplary diagram for explaining a subscriber-generated media method according to an embodiment of the present disclosure.

FIG. 3 is an exemplary diagram for explaining a feature extraction process in a subscriber terminal according to an embodiment of the present disclosure.

FIG. 4 is an exemplary diagram for explaining a process in which a node server merges feature vector data according to an embodiment of the present disclosure.

FIG. 5A is a diagram for explaining a process in which a node server simply merges feature vector data of audio information according to an embodiment of the present disclosure.

FIG. 5B is a diagram for explaining a process in which a node server restores, merges, and extracts feature data of audio information according to an embodiment of the present disclosure.

FIG. 6 is a diagram for explaining a process in which a node server merges and reconstructs features of video information according to an embodiment of the present disclosure.

FIG. 7 is a diagram for explaining a process in which a control server generates upstream media according to an embodiment of the present disclosure.

FIG. 8 is a flowchart for explaining a subscriber-generated media method according to an embodiment of the present disclosure.

FIG. 9 is a block diagram schematically illustrating an exemplary computing device that may be used to implement the method or apparatus described in the present disclosure.

### DETAILED DESCRIPTION

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

The following detailed description, together with the accompanying drawings, is intended to describe exemplary embodiments of the present invention, and is not intended to represent the only embodiments in which the present invention may be practiced.

The purpose of the present disclosure is not merely to classify or process information, but to simultaneously secure media quality and network efficiency through real-time processing of large-scale upstream media traffic, time alignment based on clock synchronization, and data merging among a plurality of subscribers, which could not be handled by conventional systems. The present disclosure is designed based on interworking structures among actual devices and temporal consistency in order to solve the above-described technical problems, and is clearly distinguished from conventional simple information analysis or artificial intelligence processing.

The present disclosure is not limited to simple data classification or artificial intelligence processing, but is implemented within a communication network architecture based on cooperative operations among subscriber terminals, node servers, and a control server. The control server precisely synchronizes internal clocks of the subscriber terminals and the node servers, and dynamically transmits guide messages including parameters and configuration values to be applied to a generative AI model in accordance with predefined protocols, thereby simultaneously ensuring quality and real-time performance of upstream media. Such a configuration goes beyond mere execution of algorithms and constitutes a technical implementation that operates on a plurality of actual computing devices and transmission networks.

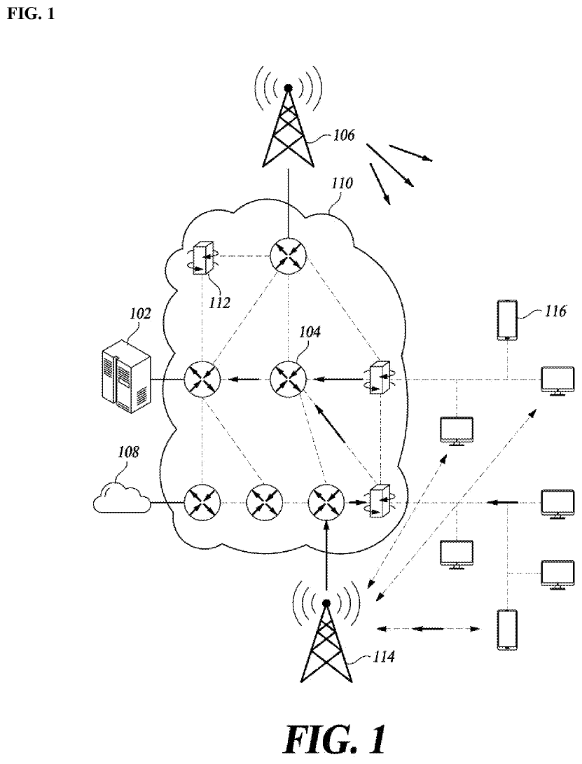

FIG. 1 is an exemplary diagram illustrating a conventional one-way media providing method.

Traditional broadcast media, such as terrestrial broadcasting, cable broadcasting, satellite broadcasting, and Internet Protocol Television (IPTV), transmit programs provided by program providers after processing the programs at a headend (102) of a broadcasting and telecommunications service provider. The transmitted media are delivered to subscriber terminals (116) in different manners depending on the type of subscriber network. For example, in the case of terrestrial broadcasting, media transmitted from the headend (102) are delivered to a terrestrial transmission station (106) through a wired or wireless backbone network (110), and are then transmitted from the terrestrial transmission station (106) to the subscriber terminals (116) via terrestrial broadcasting. In the case of cable broadcasting or IPTV, media transmitted from the headend (102) are distributed through a dedicated media line to routers (104) of the backbone network (110) and further to distributed servers such as Content Delivery Network (CDN) servers (112), and are then delivered to the subscriber terminals (116) through a Hybrid Fiber-Coaxial (HFC) network or a subscriber Internet network. In the case of Over-The-Top (OTT) services, media are transmitted from a content server (108) to the subscriber terminals (116) through the subscriber Internet network. Since media are transmitted over an IP-based network, unlike conventional broadcast media, transmission quality is not guaranteed. As a result, degradation in quality or transmission failures may occur due to transmission delays or an increase in the number of simultaneous connections. In order to address the problem of transmission quality degradation, Internet media service providers deploy Content Delivery Network (CDN) servers (112) in a distributed manner at locations close to subscriber networks, cache media traffic at the CDN servers (112), and rapidly deliver the cached media to subscriber terminals, thereby improving transmission quality.

Since conventional approaches are based on one-way media transmission, it is difficult to smoothly support bidirectional media services in which content generated by subscriber terminals (116) is transmitted in an upstream direction. This is because an upstream path is not separately constructed in existing systems, or, as in terrestrial broadcasting and satellite broadcasting, an upstream path itself is not provided. When an upstream path is not provided, a situation arises in which a subscriber must transmit upstream media data using a separate Internet network. Here, the separate Internet network may include LTE, 5G, and wired networks.

A structure in which upstream media are transmitted using a separate Internet network has the following problems. First, since conventional networks have a point-to-point link structure, the number of links and the amount of transmission traffic increase rapidly as the number of subscribers increases. Second, media traffic generated by subscriber terminals (116) is processed individually, which makes it difficult to ensure quality and synchronization. Third, as subscriber-participatory content based on audio, video, and text, beyond simple A/V response data, is generated in the upstream direction, limitations arise in terms of network capacity and maintaining media quality.

The present disclosure provides a method and an apparatus capable of generating and transmitting high-quality upstream media data by solving the problems of the related art, through deep learning-based classification and feature extraction of media data generated by subscriber terminals (116), sorting based on timing information, merging of feature vectors collected from a plurality of subscriber terminals (116), and media restoration using a generative AI model.

The present disclosure synchronizes internal clocks of subscriber terminals and node servers based on reference timing information generated by a control server, and extracts and merges feature vector data based on feature extraction guide messages and feature merge guide messages. The present disclosure enables securing quality and temporal consistency of data generated by each subscriber terminal by merging and reconstructing feature vector data on a subscriber-group basis. The present disclosure allows media traffic generated by subscriber terminals to be efficiently collected and processed and reconstructed with high quality, reduces waste of network resources, and implements a stable media provision environment.

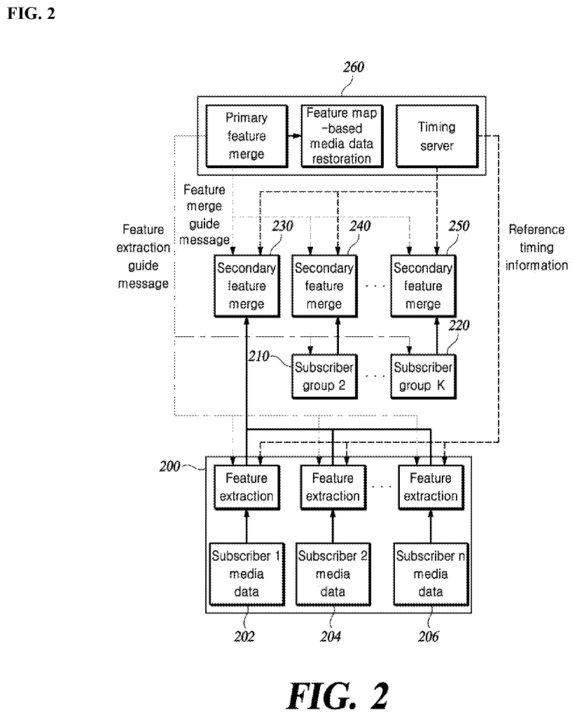

FIG. 2 is an exemplary diagram for explaining a subscriber-generated media method according to an embodiment of the present disclosure.

Subscriber groups (200, 210, and 220) are composed of a plurality of subscriber terminals connected to the same node servers (230, 240, and 250). Each subscriber terminal extracts feature vector data based on subscriber-generated media data (202, 204, and 206). The subscriber terminal may insert time information indicating a time point at which features are extracted (timestamps) into the feature vector data and transmit the feature vector data to a connected node server (230, 240, and 250).

The subscriber terminal itself or a separate network access device linked to the subscriber terminal may extract features from the subscriber-generated media data (202, 204, and 206). Feature extraction criteria may follow a feature extraction guide message transmitted by a control server (260). The feature extraction guide message may include information such as types of features, parameters, and extraction periods, and may be transmitted to the subscriber terminal or the terminal access device through a downstream according to a predefined protocol. The subscriber terminal performs deep learning-based classification and feature extraction, and the generated feature vector data are transmitted to the node server in the form of compressed audio, video, or keywords.

The node servers (230, 240, and 250) may be located at intermediate points between a subscriber network and a backbone network. For example, a node server may be a CDN server. When a CDN server is implemented as a node server (230, 240, and 250), communication efficiency may be improved because both downstream and upstream processing can be simultaneously performed for each subscriber terminal connected to the CDN server. A set of subscriber terminals connected to one CDN server may be defined as one subscriber group (200, 210, and 220). The node servers (230, 240, and 250) may sort and merge feature vector data (202, 204, and 206) received from a plurality of subscriber terminals in chronological order based on a feature merge guide message received from a control server (260). The merging performed by the node servers (230, 240, and 250) refers to feature vector data merging as described in the claims, and is referred to as secondary feature merge in FIG. 2. The node servers (230, 240, and 250) may transmit the merged feature vector data to the control server (260).

The control server (260) may merge the merged feature vector data again in consideration of temporal consistency and quality. In FIG. 2, the merging performed by the control server (260) is referred to as primary feature merge. The feature vector data on which the primary feature merge has been performed may be used as an input for feature map-based media reconstruction. Here, the feature map-based media reconstruction refers to “media data restoration” in the claims. The control server (260) may restore media data using a generative AI model based on the feature vector data subjected to the primary feature merge. Here, the generative AI model may include a GAN. The generative AI model according to an embodiment of the present disclosure does not limit a model architecture, and may use various pre-trained structures such as BERT, CNN, and transformer.

The control server (260) may receive feature vector data from a plurality of subscriber terminals and node servers (230, 240, and 250), and may generate upstream media data by merging the feature vector data according to time synchronization criteria. The control server (260) may restore and reconstruct the upstream media data using a generative AI model, thereby providing upstream media data suitable for service purposes. The control server (260) may transmit the generated upstream media data to subscriber terminals, and may control configuration values and parameters on a subscriber-group basis (200, 210, and 220).

Since the feature vector data generated by the subscriber terminals and the node servers (230, 240, and 250) are processed together with time information, the control server (260) transmits reference timing information to the subscriber terminals and the node servers (230, 240, and 250) for synchronization among the feature vector data. The control server (260) may also establish synchronization criteria by receiving timing information from a common timing server. For synchronization, Network Time Protocol (NTP), Precision Time Protocol (PTP), and preamble-based timing information of an ATSC 3.0 broadcast network may be utilized.

The present disclosure may be widely applied not only to news, broadcasting, and streaming platforms, but also to education, entertainment, and user community-based service platforms.

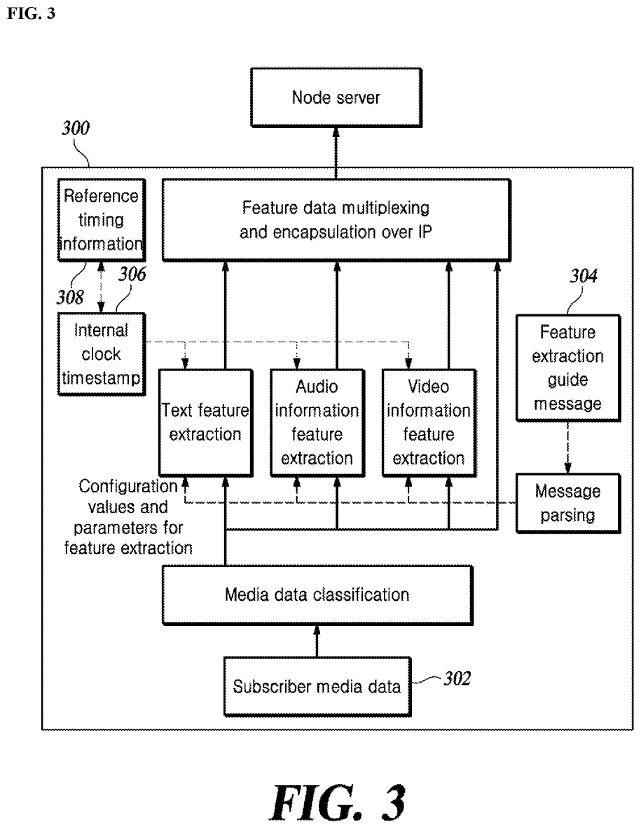

FIG. 3 is an exemplary diagram for explaining a feature extraction process in a subscriber terminal according to an embodiment of the present disclosure.

A subscriber terminal (300) or a subscriber device connected to the terminal may receive media data or traffic generated by a subscriber and extract features therefrom. The subscriber terminal (300) may classify subscriber media data (302) into one of video, audio, and text. The classified media data may be delivered to a feature extraction processing unit appropriate for the corresponding type. When the classified media data do not correspond to any of the three types, the media data may be transmitted as is to the node servers (230, 240, and 250) without separate processing. The subscriber terminal (300) may extract and transmit only features suitable for an application service based on a feature extraction guide message (304) received from a control server (260). Configuration values and parameters of a deep learning model defined by the control server (260) may vary depending on a type of a service in which the subscriber participates, and accordingly, a configuration of a feature extraction function may vary. When a deep learning model is used in the subscriber terminal (300) for feature extraction, the subscriber terminal (300) downloads configuration values and parameters to be applied to the deep learning model through the feature extraction guide message.

For example, when a service in which a subscriber participates is an online performance service, a performance service provider may observe reactions of audiences, reconstruct the reactions into a new video, and use the reconstructed video as a background screen of the online performance. The subscriber terminal (300) may extract and transmit only performance-related features such as facial expressions, gestures, and voices of audiences, and may deactivate a text-related feature extraction function. In order to extract features of performance-viewing audiences, the control server (260) may transmit a feature extraction guide message including pre-defined deep learning model parameters to the subscriber terminal (300). The subscriber terminal (300) may download configuration values and parameters of a pre-defined deep learning model to configure the deep learning model for feature extraction. When a subscriber switches from the online performance to another service, the feature extraction function needs to be switched to a feature extraction function suitable for the service to be switched to.

The subscriber terminal (300) synchronizes an internal clock timestamp (306) based on reference timing information (308) provided by the control server (260). As described above, extraction and merging of feature vector data are not limited to operations within a single device, but are distributively performed in a plurality of subscriber terminals and node servers in which timing synchronization is achieved, and a restoration process of a generative AI model may be executed in a computation module embedded in the control server. A complex system architecture according to the present disclosure is realized in a specific hardware structure and network environment, unlike conventional abstract signal processing or AI classification schemes, and as a result, provides technical effects such as real-time media synchronization, enhanced immersion, and traffic light-weighting. The subscriber terminal (300) may transmit extracted feature vector data to the node servers (230, 240, and 250) together with timestamp information. In order to provide accurate time information of a feature extraction time point, the subscriber terminal (300) may synchronize an internal clock by referring to the reference timing information (308). Here, the timestamp inserted into the extracted feature vector data may include time information indicating a time point at which features are extracted.

Meanwhile, when a feature extraction function is deactivated according to a service configuration, the subscriber terminal (300) transmits subscriber-generated media data (302) or traffic data to the node servers (230, 240, and 250) as is, without separate processing.

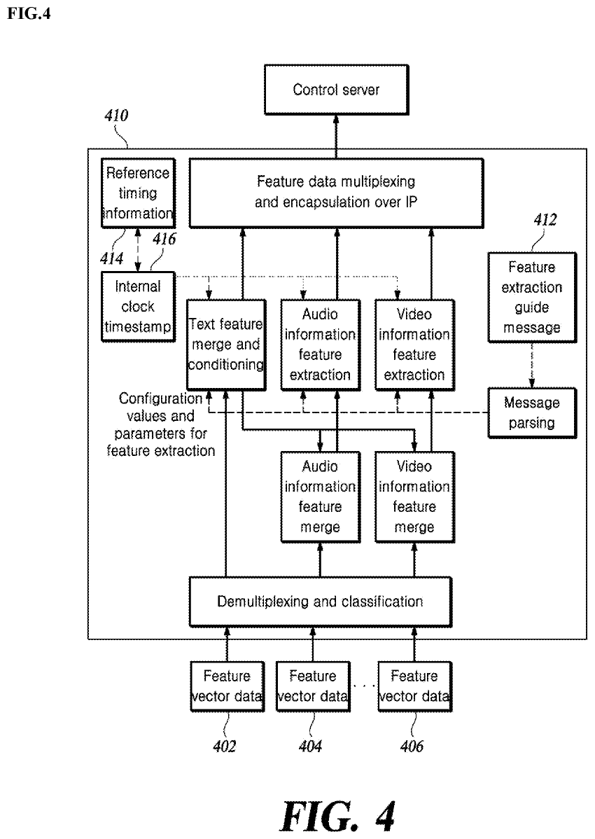

FIG. 4 is an exemplary diagram for explaining a process in which a node server merges feature vector data according to an embodiment of the present disclosure.

The node server (410) may merge feature vector data (402, 404, and 406) received from a plurality of subscriber terminals (300) based on a feature merge guide message (412) received from the control server (260). The feature merge guide message (412) may include a merge interval, a merge quantity, an applied model type, and a timestamp tolerance range. For example, the feature merge guide message (412) may be configured in a JSON format and may include field names such as “merge_interval,” “merge_size,” “model_type,” and “timestamp_tolerance.” Each field may be used to designate a merge interval, a merge quantity, a type of a generative AI model, and a timestamp tolerance range.

The feature vector data (402, 404, and 406) may be transmitted to the node server (410) through multiplexing and encapsulation over IP. For example, the multiplexing and encapsulation over IP may use a format based on Real-time Transport Protocol (RTP) or MPEG Transport Stream (MPEG-TS). The feature vector data may be inserted into a payload area of an RTP packet or configured as a Packetized Elementary Stream (PES) within an MPEG-TS stream in order to improve transmission efficiency.

The node server (410) may demultiplex feature vector data (402, 404, and 406) and classify the demultiplexed feature vector data into one of audio information, video information, and text.

The classified feature vector data may be individually processed according to each type. The node server (410) may download configuration values and parameters to be applied to a generative AI model from a feature extraction guide message. The node server (410) may restore feature vector data classified as audio information into one or more audio signals using the generative AI model, or may merge some or all features based on a number or a configuration set by the control server (260). Here, the number or the configuration set by the control server (260) may be included in configuration values and parameters downloaded from the feature extraction guide message. For example, features separately designated by the control server (260) may be output in a separated state without being merged. The node server (410) may extract information such as a signal level, a frequency range, and a signal strength from feature vector data classified as audio information and may perform merging using the extracted information. The node server (410) may perform condition-based media restoration by applying conditions such as context information or keyword information extracted from feature vector data classified as text to the generative AI model. Here, the condition information may be information extracted together in a process of merging feature vector data classified as text. Since audio feature data received from the subscriber terminal (300) are in a state in which only features are extracted at the subscriber terminal (300), the audio feature data may be restored to a state capable of being reprocessed when necessary, and features may be extracted again from the restored signals.

The node server (410) may merge and restore feature vector data classified as video information in a manner similar to that described above. The node server (410) may restore feature vector data classified as video information into video data using a generative AI model. The node server (410) may perform condition-based media restoration by applying condition information extracted from feature vector data classified as text to the AI model. Here, the generative AI model may be a pre-trained model based on configuration values and parameters provided by the control server (260) and condition information extracted from the feature vector data classified as text. The node server (410) may merge some or all of video feature vector data based on the feature merge guide message. The node server (410) may extract features from the merged feature vector data and transmit the extracted feature vector data to the control server (260).

The node server (410) may merge feature vector data classified as text into one or more text data items according to a predetermined numerical value included in the feature merge guide message. The node server (410) may extract metadata such as a keyword occurrence count and context information from the reconstructed text. The extracted metadata may be used as condition information in video and audio restoration processes. After text merging, feature vector data may be extracted again from the merged text as necessary and may be included in a process of multiplexing and transmitting merged feature vector data.

The node server (410) may sort and merge feature vector data in chronological order based on a time point at which the feature vector data are extracted, by referring to timestamps included in respective feature vector data during merging and restoration processes. Here, the timestamp included in each feature vector data may include time information indicating a time point at which the feature vector data are extracted. The node server (410) may synchronize an internal clock timestamp (416) based on reference timing information (414) received from the control server.

The node server (410) may transmit the merged feature vector data to the control server (260). The control server (260) may generate upstream media data based on the merged feature vector data, or may transmit the generated upstream media data to a plurality of subscriber terminals. In an embodiment according to the present disclosure, the node server (410) may be located within a CDN server for downstream processing. In an embodiment according to the present disclosure, the CDN server may reduce downstream load from a headend control server (260) to subscriber terminals (300). When the node server (410) is implemented as a CDN server, load balancing parameters used in downstream processing may be shared for upstream processing, thereby managing an overall system load more efficiently.

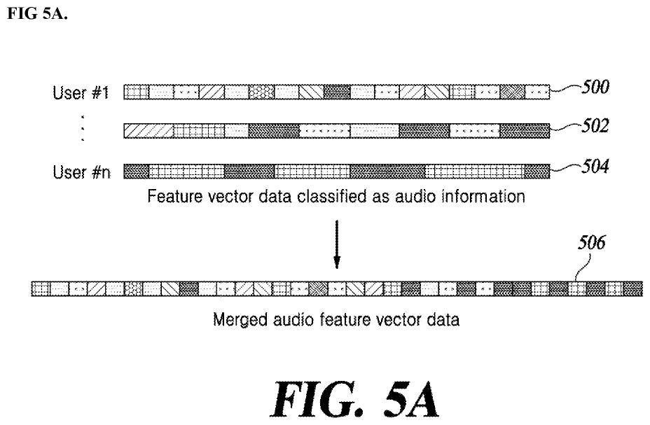

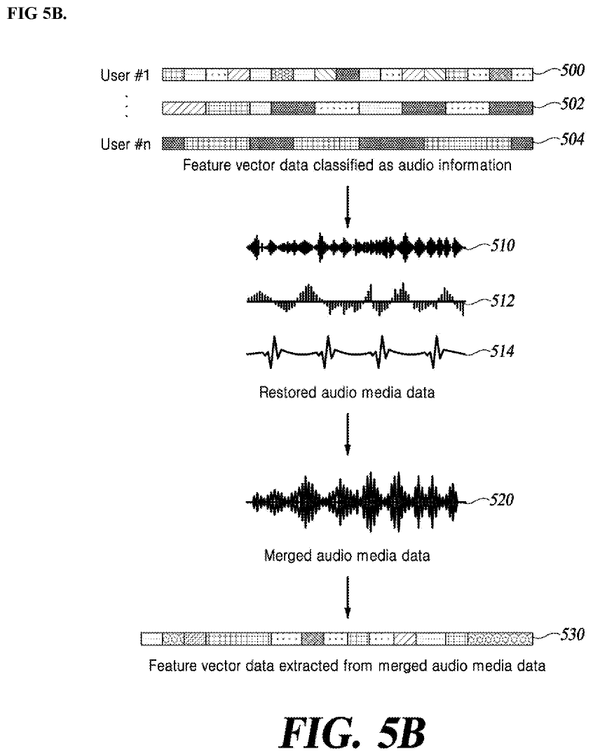

FIG. 5A is a diagram for explaining a process in which a node server simply merges feature vector data of audio information according to an embodiment of the present disclosure.

The subscriber terminal (300) may extract feature vector data from media data classified as audio information based on a feature extraction guide message (304) generated by the control server (260). Features to be extracted may include a spectrum of an audio signal, an audio signal equal to or greater than a predetermined value, or an audio signal suitable for a purpose of a service in which a subscriber participates. For example, when subscriber-generated media data (202, 204, and 206) correspond to reactions to a performance, the subscriber terminal (300) may extract only a human voice and applause sounds and include the extracted features in the feature vector data. The extracted feature vector data may be transmitted to the node server (410) through multiplexing and encapsulation over IP. The feature vector data may be transmitted to the node server (410) using a network path configured as an upstream. The node server (410) may demultiplex and classify feature vector data received from a plurality of subscriber terminals (300). The node server (410) may classify the feature vector data into one of audio information, video information, and text. The node server (410) may merge feature vector data (500, 502, and 504) classified as audio information based on a feature merge guide message (412). The feature merge guide message (412) may include configuration values for feature merging and parameters to be applied to a deep learning model. Here, reference numeral 500 may denote feature vector data extracted from subscriber 1, reference numeral 502 may denote feature vector data extracted from subscriber x, and reference numeral 504 may denote feature vector data extracted from subscriber n, which are classified as audio information. Here, x is a natural number greater than or equal to 1 and less than n, and n is a natural number.

There may be two methods by which the node server (410) merges feature vector data classified as audio information. First, the node server (410) may merge the feature vector data into a single integrated feature vector data without a restoration process and output the merged feature vector data. In some embodiments according to the present disclosure, the node server (410) may simply merge audio feature vector data received from a plurality of subscriber terminals (300) into a single feature vector data without restoring or reconstructing the audio feature vector data. The node server (410) may output merged audio feature vector data (506) as a result of the merging process. In some embodiments in which merging is performed without a restoration or reconstruction process, computational burden of the node server (410) is reduced, thereby minimizing processing delay and increasing real-time processing speed, and thus enabling large-scale real-time feature merging.

During the merging process, the node server (410) may sort the feature vector data based on chronological order by using timestamp information included in the feature vector data (500, 502, and 504). The node server (410) may transmit the merged audio feature vector data (506) to the control server (260).

Second, the node server (410) may restore feature vector data of an audio signal and merge audio signals on the basis of the feature merge guide message (412) of the control server (260). The second merging method will be described in detail with reference to FIG. 5B.

FIG. 5B is a diagram for explaining a process in which a node server restores, merges, and extracts feature data of audio information according to an embodiment of the present disclosure.

The subscriber terminal (300) may extract feature vector data from media data classified as audio information based on a feature extraction guide message (304) generated by the control server (260). The extracted feature vector data may be transmitted to the node server (410) through a network path configured as an upstream after multiplexing and encapsulation over IP. The node server (410) may demultiplex and classify the feature vector data received from the subscriber terminal (300). The node server (410) may restore and merge feature vector data (500, 502, and 504) classified as audio information based on a feature merge guide message (412). The node server (410) may restore the feature vector data (500, 502, and 504) into audio media data using a generative AI model. For example, feature vector data (500) extracted from subscriber 1 and classified as audio information may be restored into audio media data (510) through a restoration process, feature vector data (502) extracted from subscriber x and classified as audio information may be restored into audio media data (512) through a restoration process, and feature vector data (504) extracted from subscriber n and classified as audio information may be restored into audio media data (514) through a restoration process. Here, the generative AI model may be a model trained based on a training dataset including context information and keyword information extracted from feature data classified as text in advance. The generative AI model may apply parameters and configuration values included in the feature merge guide message (412) generated by the control server (260). During the restoration process, context information or keyword information of audio may be reflected together with the parameters and configuration values.

The node server (410) may sort the restored audio media data (510, 512, and 514) along a time axis and may merge the restored audio media data into one or more audio media data according to configuration values designated by the control server (260). For example, in an online performance service, various types of audio such as audience cheers and applause sounds may exist. The node server (410) may mix the audio data into one audio media data or may merge the audio data by separating the audio data into different media data. The node server (410) may mix the restored audio media data (510, 512, and 514) into one audio media data or may reconstruct the restored audio media data into a plurality of audio media data based on configuration values designated by the control server (260). Here, the configuration values designated by the control server (260) may include a numerical value indicating into how many audio media data the restored audio media data (510, 512, and 514) are to be reconstructed. The merging process performed by the node server (410) may vary according to conditions and configuration values included in the feature merge guide message (412). A result of the merging performed by the node server (410) may be merged audio media data (520).

The node server (410) may extract features again from the merged audio media data (520) to generate merged audio feature vector data (530). The feature vector data (530) extracted from the merged audio media data (520) may include refined information suitable for a service purpose. The node server (410) may transmit the merged audio feature vector data (530) to the control server (260). An embodiment according to the present disclosure has an effect of improving accuracy and expressiveness of data integration by restoring and merging feature vector data received from a plurality of subscriber terminals and then re-extracting features.

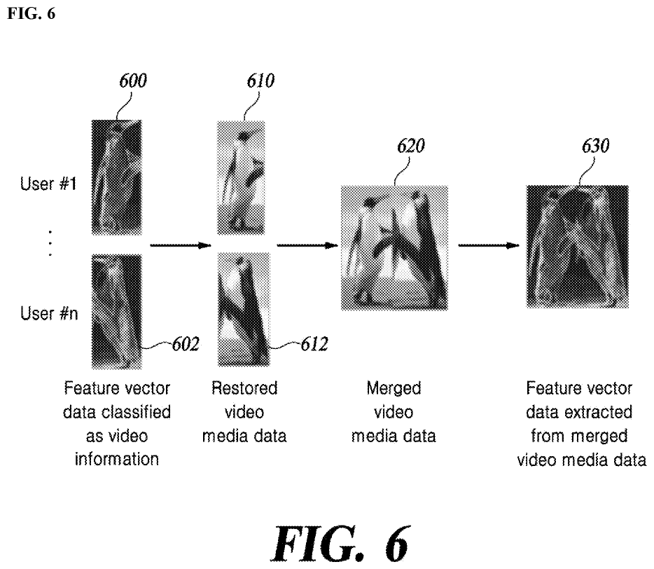

FIG. 6 is a diagram for explaining a process in which a node server merges and reconstructs features of video information according to an embodiment of the present disclosure.

The node server (410) may merge feature vector data classified as video information in two methods, similarly to audio information.

First, the node server (410) may merge the feature vector data without a restoration process. For example, the node server (410) may configure merged video feature vector data by sorting feature vector data (600) extracted from subscriber 1 and feature vector data (602) extracted from subscriber n in chronological order and then merging the sorted feature vector data into one or more merged video feature vector data, without performing a restoration process.

Second, the node server (410) may restore feature vector data classified as video information into video media data using a generative AI model and may reconstruct the restored video media data into one or more video data based on a feature merge guide message (412) generated by the control server (260). Specifically, the subscriber terminal (300) may extract feature vector data from media data classified as video information based on a feature extraction guide message (304) generated by the control server (260). Feature extraction methods may include traditional video processing techniques such as video edge detection, color information reduction, and removal of high-frequency components, or techniques using a deep learning model. The subscriber terminal (300) may extract video features suitable for a service purpose in which the subscriber participates based on the feature extraction guide message (304). For example, when a service in which the subscriber participates is an online performance service, the subscriber terminal (300) may extract only features related to audience reactions during the performance and may not extract features related to a background or surrounding persons. The subscriber terminal (300) may transmit the extracted video feature vector data to the node server (410) by multiplexing and encapsulating the extracted video feature vector data over IP through a network path configured as an upstream.

The node server (410) may demultiplex video feature vector data received from the subscriber terminal (300) and classify the demultiplexed feature vector data into audio information, video information, and text. The node server (410) may restore feature vector data (600, 602) classified as video information based on a feature merge guide message (412). For example, video feature vector data (600) extracted from subscriber 1 may be restored into video media data (610) through a restoration process, and video feature vector data (602) extracted from subscriber n may be restored into video media data (612) through a restoration process. The node server (410) may restore video data using a generative AI model. Here, the generative AI model may be a model trained in advance based on a training dataset including context information and keyword information extracted from merged text data. The generative AI model may apply parameters and configuration values included in the feature merge guide message (412) generated by the control server (260).

The node server (410) may synchronize an internal clock timestamp (416) by referring to reference timing information (414) received from the control server (260). By synchronizing the timestamps, the node server (410) may compensate for time differences among subscriber terminals and may merge and reconstruct feature vector data in a synchronized state. The node server (410) may sort feature vector data (600 and 602) classified as video information and restored video media data (610 and 612) in chronological order based on timestamp information included in each feature vector data. Here, the timestamp information may be time information indicating a time point at which each feature vector data is extracted, and may be used as a reference for accurately sorting and merging data received from a plurality of subscriber terminals.

The node server (410) may mix the restored video media data into one video media data or reconstruct the restored video media data into a plurality of video media data based on configuration values designated by the control server (260). Here, the configuration values designated by the control server (260) may include a numerical value indicating into how many video media data the restored video media data (620) are to be reconstructed. For example, the restored video media data may be reconstructed into a plurality of video media data according to a type of a recognized object. Here, the type of the recognized object may include a person, a building, and a vehicle. The node server (410) may reconstruct the restored video media data (610 and 612) into merged video media data (620).

The node server (410) may re-extract features from the merged video media data (620). Feature vector data (630) extracted from the merged video media data (620) may represent feature vector data re-extracted by the node server (410). The extracted feature vector data may include information refined to suit service purposes. The node server (410) may transmit the feature vector data (630) extracted from the merged video media data to the control server (260).

According to an embodiment of the present disclosure, by restoring and merging feature vector data classified as video information and then re-extracting features from the merged video media data, video information received from a plurality of subscriber terminals can be integrated while maintaining visual consistency and temporal coherence, thereby improving expressiveness of media generated by the subscriber terminals.

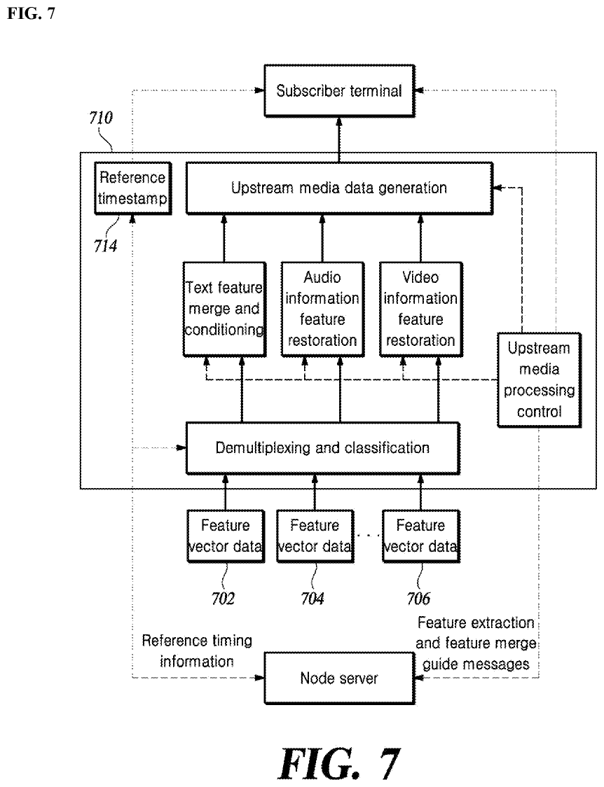

FIG. 7 is a diagram for explaining a process in which a control server generates upstream media according to an embodiment of the present disclosure.

The control server (710) may restore audio data and video data based on feature vector data (702, 704, and 706) received from a plurality of node servers (230, 240, and 250). The control server (710) may restore the feature vector data into media data by using a generative AI model. The generative AI model may be trained by using, as input values, feature vector data extracted based on media data generated by a plurality of subscriber terminals. During a training process, the input values may include context information, keyword information, facial position information, and voice pitch information, and output values may be configured as media restoration results such as video frame data, audio waveforms, or text data.

The control server (710) may reconstruct the restored media data to be suitable for purposes of a subscriber participation service and generate upstream media data. For example, the control server (710) may render video data of subscribers participating in a performance viewing service into a single large display, or may generate new video data by using the generative AI model based on video data of subscribers performing a specific action.

The configuration of the upstream media may be structured based on configuration values determined by a control module within the control server (710) and input values of a service provider. For example, the upstream media may be generated by combining media data of subscribers according to a purpose of a service. Alternatively, the upstream media may be generated in a manner of selectively combining media data according to preconfigured conditions. The control server (710) may generate reference timing information including a reference timestamp (714) for time synchronization with the subscriber terminal (300) and the node server (410), and may transmit the reference timing information to the subscriber terminal (300) and the node server (410). Here, the reference timestamp (714) may refer to reference time information. The control server (710) may generate a feature extraction guide message (304) and a feature merge guide message (412) in order to control processes of feature extraction and feature merging performed by the subscriber terminal (300) and the node server (410), and may transmit the feature extraction guide message and the feature merge guide message to each of the subscriber terminal (300) and the node server (410). The feature extraction guide message (304) and the feature merge guide message (412) may include types of features to be extracted, an extraction period, a merge quantity, and configuration values and parameters to be applied to a generative AI model, and may be utilized as criteria for improving quality and temporal consistency of an upstream media configuration.

In some embodiments according to the present disclosure, the control server (710) may receive feature vector data from a plurality of node servers (230, 240, and 250). Here, the feature vector data received from the plurality of node servers may be data. The control server (710) may demultiplex the feature vector data multiplexed and encapsulated over IP, classify the feature vector data into any one of audio information, video information, and text, and then restore and reconfigure the data into upstream media using a generative AI model.

The control server (710) may re-extract features from the restored and reconfigured upstream media data. The re-extracted feature vector data may include meta information such as context information and keyword information. The control server (710) may perform subsequent analysis, construct training data, and generate advanced content based on the re-extracted feature vector data. The generative AI model may be trained based on a training dataset including the re-extracted feature vector data. The re-extracted feature vector data may be utilized as refined information suitable for a service purpose, and may be regarded as part of a subsequent processing procedure performed by the control server (710).

The control server (710) may transmit the upstream media data to a plurality of node servers. Each node server may transmit the upstream media data to subscriber terminals or may directly transmit the upstream media data to a service platform.

According to an embodiment of the present disclosure, the control server performs merging and restoration of feature vector data on the basis of time synchronization, and re-extracts features from the restored media, thereby providing a high-quality upstream media service in which visual consistency and temporal coherence are ensured.

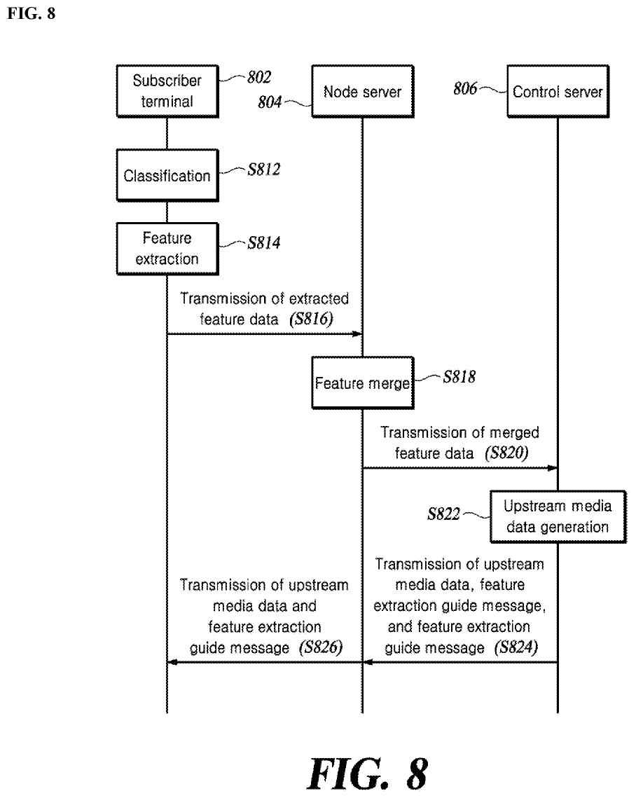

FIG. 8 is a flowchart for explaining a subscriber-generated media method according to an embodiment of the present disclosure.

The subscriber terminal (802) applies media data generated by the subscriber terminal (802) as input values to a deep learning model to classify the media data into one of audio information, video information, and text (S812). After the step S812, the method may further comprise synchronizing, by the subscriber terminal (802), an internal clock (local synchronized clock) of the subscriber terminal (802) on the basis of reference timing information (308) generated by the control server (806).

The subscriber terminal (802) extracts preconfigured types of features from the classified media data using the deep learning model, on the basis of a feature extraction guide message (304) generated by the control server (806) and including configuration values for feature extraction and parameters to be applied to the deep learning model (S814). After the step S814, the step S814 may further comprise multiplexing and encapsulating the feature vector data over IP by the subscriber terminal (802).

The subscriber terminal (802) inserts a timestamp, which is time information at which features are extracted, into feature vector data, and transmits the feature vector data to a node server (804) to which the subscriber terminal (802) is connected (S816). The step S816 may comprise transmitting, by the subscriber terminal (802), the feature vector data multiplexed and encapsulated over IP to the node server (804). After the step S816, the method may further comprise receiving, by the subscriber terminal (802), upstream media data and the feature extraction guide message (304) generated by the control server (806), from the node server (804).

The node server (804) sorts and merges feature vector data received from a plurality of subscriber terminals (802) included in a subscriber group connected to the node server (804), in chronological order on the basis of timestamps included in the feature vector data and indicating time information at which the feature vector data are extracted, on the basis of a feature merge guide message (412) generated by the control server (806) and including configuration values for merging feature vector data and parameters to be applied to a deep learning model (S818). Here, the feature vector data received from the plurality of subscriber terminals (802) may be feature vector data multiplexed and encapsulated over IP based on the feature vector data.

Before the step S818, the method may further comprise synchronizing, by the node server (804), an internal clock of the node server (804) on the basis of reference timing information (308) generated by the control server (806). Before the step S818, the method may further comprise demultiplexing, by the node server (804), the feature vector data multiplexed and encapsulated over IP, and classifying the demultiplexed feature vector data into one of audio information, video information, and text. Before the step S818, the method may further comprise, when the classified feature vector data are audio information or video information, restoring, by the node server (804), the feature vector data into media data generated by the subscriber terminal (802) by using a generative AI model.

The step S818 may comprise, when the classified feature vector data are text, reconstructing, by the node server (804), feature vector data classified as text into one or more text data according to a predetermined numerical value included in the feature merge guide message (412), and extracting, by the node server (804), feature vector data from the reconstructed text data.

Here, when the classified feature vector data are audio information or video information, the restoring, by the node server (804), of the feature vector data into media data generated by the subscriber terminal (802) by using a generative AI model may include restoring the feature vector data into the media data by using a generative AI model trained using a training dataset including features extracted from reconstructed text data. Here, the features extracted from the reconstructed text data may include context information and keyword information.

The step S818 may comprise, when the classified feature vector data are audio information or video information, generating, by the node server (804), one or more media data from a plurality of restored media data by using a generative AI model according to a predetermined numerical value included in the feature merge guide message (412). Here, the generative AI model may be a model trained using a training dataset including feature vector data extracted from one or more merged text data when the classified feature vector data are audio information or video information.

The step S818 may further comprise, when the classified feature vector data are text, reconstructing, by the node server (804), the feature vector data classified as text into one or more text data according to a predetermined numerical value included in the feature merge guide message (412), and extracting feature vector data from the one or more merged text data.

After the step S818, when the classified feature vector data are audio information or video information, the step S818 may further comprise extracting, by the node server (804), feature vector data from the reconstructed media data.

The node server (804) transmits the merged feature vector data to the control server (806) (S820). Before the step S820, the method may further comprise multiplexing and encapsulating over IP, by the node server (804), at least one of feature vector data extracted from the one or more merged text data and feature vector data extracted from the one or more reconstructed media data, to generate upstream streams. The step S820 may comprise transmitting, by the node server (804), the generated upstream streams to the control server (806).

The control server (806) generates upstream media data by using a generative AI model based on the merged feature vector data (S822). Before the step S822, the method may further comprise sorting, by the control server (806), feature vector data received from a plurality of subscriber terminals belonging to the same subscriber group as the subscriber terminal (802), in chronological order based on reference timing information, and merging the feature vector data based on a feature merge guide message (412) generated by the control server (806) and including configuration values for merging feature vector data and parameters to be applied to a deep learning model. Before the step S822, the method may further comprise demultiplexing, by the control server (806), upstream streams received from a plurality of node servers (804), classifying demultiplexed feature vector data into one of audio information, video information, and text, and restoring, by the control server (806), the classified feature vector data using the generative AI model.

The step S822 may include generating, by the control server (806), upstream media data by using a generative ai model based on restored data.

The control server (806) transmits the upstream media data to a plurality of node servers (804), and generates and transmits reference timing information, a feature extraction guide message, and a feature merge guide message to the node servers (804) (S824).

The node servers (804) transmit the upstream media data generated by the control server (806) to a plurality of subscriber terminals (802), and transmit, to the subscriber terminals (802), a feature extraction guide message (304) including parameters to be applied to a deep learning model included in the subscriber terminals (802), and reference timing information (414) (S826).

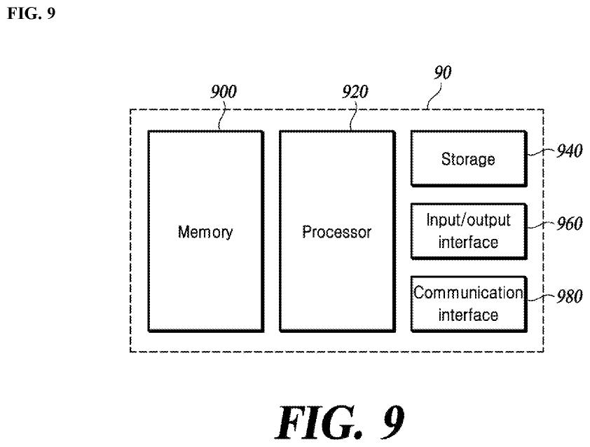

FIG. 9 is a block diagram illustrating an exemplary computing device that may be used for implementing a method or an apparatus according to the present disclosure.

The computing device (90) may include all or part of a memory (900), a processor (920), a storage (940), an input/output interface (960), and a communication interface (980). The computing device (90) may structurally and/or functionally include at least a portion of the subscriber terminal (300), the node server (410), or the control server (710). The computing device (90) may be a stationary computing device, such as a desktop computer or a server, or a mobile computing device, such as a laptop computer or a smart phone. The computing device (90) may also include any specialized hardware accelerator capable of processing operations for an artificial intelligence model in an efficient manner. For example, the computing device (90) may include a graphic processing unit (GPU), a Tensor Processing Unit (TPU), or a neural processing unit (NPU).

The memory (900) may store a program that enables the processor (920) to perform a methods or operations according to various embodiments of the present disclosure. For example, the program may include a plurality of instructions executable by the processor (920), and the methods or operations described above may be performed by executing the plurality of instructions by the processor (920). may consist of a single memory or a plurality of memories. In this case, information required to perform the methods or operation according to various embodiments of the present disclosure may be stored in a single memory or distributed across a plurality of memories. When the memory (900) is composed of a plurality of memories, the plurality of memories may be physically separated. The memory (900) may include at least one of volatile memory and non-volatile memory. Volatile memory includes Static Random Access Memory (SRAM) or Dynamic Random Access Memory (DRAM), while non-volatile memory includes flash memory.

The processor (920) may include at least one core capable of executing at least one instruction. The processor (920) may execute instructions stored in the memory (900). The processor (920) may consist of a single processor or a plurality of processors.

The storage (940) maintains stored data even if power supplied to the computing device (90) is cut off. For example, the storage (940) may include non-volatile memory or may include a storage medium such as a magnetic tape, an optical disk, or a magnetic disk. A program stored in the storage (940) may be loaded into the memory (900) before being executed by the processor (920). The storage (940) may store files written in a program language, and a program created from the files by a compiler may be loaded into the memory (900). The storage (940) may store data to be processed by the processor (920) and/or data processed by the processor (920).

The input/output interface (960) may provide an interface with an input device such as a keyboard or a mouse and/or an output device such as a display device or a printer. The user may trigger execution of a program by the processor (920) through the input devices and/or check the processing results of the processor (920) through the output device.

The communication interface (980) may provide access to an external network. The computing device (90) may communicate with other devices through the communication interface (980). For example, the other devices may include a subscriber terminal (300), a node server (410), or a control server (710).

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Accordingly, one of ordinary skill would understand that the scope of the claimed invention is not to be limited by the above explicitly described embodiments but by the claims and equivalents thereof.

What is claimed is:

1. A subscriber-generated media transmission method comprising:
classifying, by a subscriber terminal, media data generated by the subscriber terminal into one of audio information, video information, and text by applying the media data as input to a deep learning model;
synchronizing an internal clock of the subscriber terminal as a local synchronized clock based on reference timing information generated by a control server;
extracting, by the subscriber terminal, predetermined types of features from the classified media data using the deep learning model, based on a feature extraction guide message generated by the control server and including configuration values for extracting feature vector data and parameters to be applied to the deep learning model;
inserting timestamps, which indicate times at which the features are extracted, into feature vector data, and transmitting the feature vector data to a node server to which the subscriber terminal is connected; and
receiving upstream media data generated by the control server,
wherein the upstream media data is generated using a generative AI model based on merged feature vector data obtained by merging feature vector data received from a plurality of subscriber terminals belonging to the same subscriber group as the subscriber terminal, based on a feature merge guide message generated by the control server and including configuration values for merging feature vector data and parameters to be applied to the deep learning model.

2. The method according to claim 1, wherein
the extracting of the predetermined types of features comprises multiplexing the feature vector data and encapsulating the feature vector data over IP; and
the transmitting of the feature vector data to the node server comprises transmitting the feature vector data multiplexed and encapsulated over IP to the node server.

3. A subscriber-generated media transmission method comprising:
synchronizing an internal clock of a node server based on reference timing information generated by a control server;
sorting and merging, by the node server, feature vector data received from a plurality of subscriber terminals included in a subscriber group connected to the node server, in chronological order based on timestamps included in the feature vector data and indicating times at which the feature vector data are extracted, based on a feature merge guide message generated by the control server and including configuration values for merging feature vector data and parameters to be applied to the deep learning model;
transmitting the merged feature vector data to the control server;
transmitting upstream media data generated by the control server to the plurality of subscriber terminals; and
transmitting, to the subscriber terminals, a feature extraction guide message generated by the control server and including configuration values for extracting feature vector data and parameters to be applied to the deep learning model, and the reference timing information,
wherein the upstream media data is generated using a generative AI model based on merged feature vector data obtained by merging feature vector data received from a plurality of subscriber terminals belonging to the same subscriber group, based on a feature merge guide message generated by the control server and including configuration values for merging feature vector data and parameters to be applied to the deep learning model.

4. The method according to claim 3, wherein
the feature vector data received from the plurality of subscriber terminals are feature vector data multiplexed and encapsulated over IP; and
the method further comprises:
before the sorting and merging of the feature vector data based on the feature merge guide message,
demultiplexing the feature vector data multiplexed and encapsulated over IP and classifying the demultiplexed feature vector data into one of audio information, video information, and text; and
when the classified feature vector data are audio information or video information, restoring media data generated by the subscriber terminals using a generative AI model.

5. The method according to claim 4, wherein
the sorting and merging of the feature vector data based on the feature merge guide message comprises:
when the classified feature vector data are text, reconstructing one or more text data from the feature vector data classified as text according to a predetermined numerical value included in the feature merge guide message; and
extracting feature vector data from the reconstructed text data.

6. The method according to claim 5, wherein
when the classified feature vector data are audio information or video information, the restoring of media data generated by the subscriber terminals using a generative AI model comprises:
restoring the media data using the generative AI model trained using a training dataset including features extracted from the reconstructed text data, wherein the features include at least one of context information and keyword information.

7. The method according to claim 4, wherein
the sorting and merging of the feature vector data based on the feature merge guide message comprises:
when the classified feature vector data are audio information or video information, reconstructing a plurality of media data into one or more reconstructed media data using the generative AI model according to a predetermined numerical value included in the feature merge guide message.

8. The method according to claim 7, wherein
the sorting and merging of the feature vector data based on the feature merge guide message further comprises:
when the classified feature vector data are audio information or video information, extracting feature vector data from the reconstructed media data.

9. The method of claim 7, wherein
one or more merged text data are data reconstructed from feature vector data classified as text according to a predetermined numerical value included in the feature merge guide message; and
in reconstructing a plurality of media data into one or more reconstructed media data using the generative AI model according to the predetermined numerical value included in the feature merge guide message, the generative AI model is a model trained using a training dataset including feature vector data extracted from the one or more merged text data when the classified feature vector data are audio information or video information.

10. The method according to claim 8, wherein
the sorting and merging of the feature vector data based on the feature merge guide message further comprises:
when the classified feature vector data are text, reconstructing one or more text data from the feature vector data classified as text according to a predetermined numerical value included in the feature merge guide message; and
extracting feature vector data from the one or more merged text data; and
wherein transmitting the merged feature vector data to the control server comprises:
generating upstream streams by multiplexing at least one of feature vector data extracted from the one or more merged text data and feature vector data extracted from one or more reconstructed media data and encapsulating the at least one over IP; and
transmitting the upstream streams.

11. A subscriber-generated media transmission method comprising:
sorting, in chronological order based on reference timing information, feature vector data received from a plurality of subscriber terminals belonging to the same subscriber group as a subscriber terminal, and merging the sorted feature vector data based on a feature merge guide message generated by a control server and including configuration values for merging feature vector data and parameters to be applied to a deep learning model;
generating upstream media data using a generative AI model based on the merged feature vector data;
transmitting the upstream media data to node servers; and
generating and transmitting the reference timing information, a feature extraction guide message, and the feature merge guide message to the node servers.

12. The method according to claim 11, wherein
upstream streams received from a plurality of node servers are data generated by multiplexing feature vector data extracted from the merged feature vector data and encapsulating the feature vector data over IP; and
the method further comprises:
before generating upstream media data based on the merged feature vector data,
demultiplexing the upstream streams and classifying demultiplexed feature vector data into one of audio information, video information, and text; and
restoring the classified feature vector data using the generative AI model.

13. The method according to claim 12, wherein
generating upstream media data based on the merged feature vector data comprises generating the upstream media data using the generative AI model based on restored data.

14. An apparatus comprising: at least one processor; and a memory storing instructions that, when executed by the at least one processor, cause the apparatus to perform the method of claim 3.

15. The apparatus of claim 14, wherein the memory further storing instructions that, when executed by the at least one processor, cause the apparatus to:
the feature vector data received from the plurality of subscriber terminals are feature vector data multiplexed and encapsulated over IP; and
wherein the at least one processor executes the instructions to perform: before the sorting and merging of the feature vector data based on the feature merge guide message,
demultiplexing the feature vector data multiplexed and encapsulated over IP and classifying demultiplexed feature vector data into one of audio information, video information, and text; and
when the classified feature vector data are audio information or video information, restoring media data generated by the subscriber terminals using a generative AI model.

16. The apparatus of claim 15, wherein the memory further storing instructions that, when executed by the at least one processor, cause the apparatus to:
the sorting and merging of the feature vector data based on the feature merge guide message comprises:
when the classified feature vector data are text, reconstructing one or more text data from the feature vector data classified as text according to a predetermined numerical value included in the feature merge guide message; and
extracting feature vector data from the reconstructed text data.

17. The apparatus of claim 16, wherein the memory further storing instructions that, when executed by the at least one processor, cause the apparatus to:
when the classified feature vector data are audio information or video information, the restoring of the feature vector data into media data generated by the subscriber terminals using a generative AI model comprises:
restoring the feature vector data into the media data using the generative AI model trained using a training dataset including features extracted from the reconstructed text data.

18. The apparatus of claim 15, wherein the memory further storing instructions that, when executed by the at least one processor, cause the apparatus to:
the sorting and merging of the feature vector data based on the feature merge guide message comprises:
when the classified feature vector data are audio information or video information, reconstructing a plurality of restored media data into one or more reconstructed media data using the generative AI model according to a predetermined numerical value included in the feature merge guide message.

19. The apparatus of claim 18, wherein the memory further storing instructions that, when executed by the at least one processor, cause the apparatus to:
the sorting and merging of the feature vector data based on the feature merge guide message further comprises:
when the classified feature vector data are audio information or video information, extracting feature vector data from the reconstructed media data.

20. The apparatus of claim 18, wherein the memory further storing instructions that, when executed by the at least one processor, cause the apparatus to:
one or more merged text data are data reconstructed, when the classified feature vector data are text, by reconstructing feature vector data classified as text according to a predetermined numerical value included in the feature merge guide message, and
in reconstructing the plurality of restored media data into one or more reconstructed media data using the generative AI model according to the predetermined numerical value included in the feature merge guide message, the generative AI model is a model trained based on a training dataset comprising feature vector data extracted from the one or more merged text data when the classified feature vector data are audio information or video information.
